(19) United States
(12) Patent Application Publication
(10) Pub. No.: US 2025/0240484 A1
(43) Pub. Date: Jul. 24, 2025

(54) SYSTEMS AND METHODS FOR AI-BASED DIGITAL CONTENT CENSORING

(71) Applicant: Andrew JS BALLOUN, Lilburn, GA (US)

(72) Inventor: Andrew JS BALLOUN, Lilburn, GA (US)

(21) Appl. No.: 18/417,053

(22) Filed: Jan. 19, 2024

(51) Int. Cl. H04N 21/454; G06T 7/11; H04N 21/258

(52) U.S. Cl. CPC H04N 21/4542; G06T 7/11; H04N 21/25841

(57) ABSTRACT

Disclosed are systems and methods that provide a novel framework for censoring digital content prior to the display of such content and/or at runtime of such rendering of the digital content. The framework can automatically detect and censor particular types of content from rendered content, in real time, via computerized techniques employed to monitor user activity, intercept content concurrent with such activity, and then, perform modifications at the time of display to ensure that any unwanted, unnecessary and/or inappropriate content is censored. The framework operates to securely modify and/or obfuscate viewable content to ensure that the appropriate viewing status/mode of the content is performed. Such content censoring can be at the device-level, application level and/or server-level, in that the content is curated for display upon request, but prior to its display.

### FIELD OF THE DISCLOSURE

The present disclosure is generally related to the control and management of how, when and/or where digital content can be rendered, based at least in part on a type of user and/or identity and/or location of a user, and more particularly, to a decision intelligence (DI)-based computerized framework for censoring digital content, at least a portion thereof, using artificial intelligence (AI) techniques.

### BACKGROUND

Users today face significant challenges when it comes to encountering illicit or unwanted materials while browsing the web. The Internet is a vast space with a wide array of content, and unfortunately, not all of it is suitable for all users. For example, children can accidentally stumble upon explicit or adult content while browsing innocuous websites or through pop-up ads, for example. Sometimes, even harmless searches can lead to unexpected results with inappropriate material. Even with safety filters in place, some content might slip through the cracks or bypass parental controls, exposing children to explicit material. Moreover, children today have also figured out how to get around website blockers, rendering them ineffective.

In another example, while watching videos on platforms like YouTube®, for example, there can be instances where inappropriate content appears unexpectedly—for example, through misleading video titles, thumbnails or non-labeled content within the video itself. Social media platforms, despite having age restrictions, often have content that is not suitable for particular audiences.

### SUMMARY OF THE DISCLOSURE

Accordingly, such challenges, among others, can have various negative effects on users, from confusion and discomfort, to potential desensitization or exposure to harmful concepts. For example, parents and guardians often find it challenging to keep up with the rapid changes in online content and technology their children may be using, making it difficult to provide adequate supervision and protection. In addition, adults themselves may not wish to be exposed to certain images, or have certain images appear on their screen in certain locations. While general privacy settings and mass censorship can be employed, not only is this not typically successful in filtering unwanted data, there is currently no way to monitor and modify content at the device-level and/or application-level prior to, or at least during runtime of the rendering of such content.

Accordingly, as discussed herein, the disclosed systems and methods provide novel functionality for automatically detecting and censoring particular types of content from rendered content, in real time, via computerized techniques employed to monitor user activity, intercept content concurrent with such activity, and then, perform modifications at the time of display to ensure that any unwanted, unnecessary and/or inappropriate content is censored.

According to some embodiments, it should be understood that while the discussion herein may reference content and/or media, it should not be construed as limiting, as any type of renderable information on an interface of a device or page (e.g., webpage or application) can be audited for censoring via the disclosed systems and methods. Thus, reference to content and/or media should be understood to include, but not be limited to, images, video, text, audio, applications, multi-media, augmented reality (AR), virtual reality (VR), and/or any other type of known or to be known digital information that can be displayed for viewing consumption and/or interaction by a user.

In some embodiments, the disclosed systems and methods can be applied with and/or based on location-based applications. For example, a form of a geofence can be configured around a particular location and/or a user (and/or user device), which can prohibit certain types of content from being received and/or viewed while the user is within such location. For example, this can be beneficial in professional settings, such as work, where a user may be surprised by inappropriate videos sent via messenger application.

Thus, according to some embodiments, the disclosed systems and methods enable the framework to securely modify and/or obfuscate viewable content to ensure that the proper viewing status/mode of the content is performed. In some embodiments, for example, content can be, but is not limited to, modified (in whole or in part), be subject to a contextual overlay (e.g., filter), obfuscated, replaced (in whole or in part), held in abeyance (e.g., not delivered), and the like, which can ensure that content being displayed satisfies the user and/or location's context (e.g., at work versus at home, in private; and/or an adult versus a child, and which content is appropriate for both or neither, for example). For example, in some embodiments, the disclosed framework can operate to apply a swimsuit to patrons of a nude beach, or overlay a positive message on identified hate speech. In some embodiments, the content censoring can be at the application level, in that rather than preventing particular content from being displayed, an application may be prevented from being rendered (e.g., the Reddit application and/or webpage may be blocked while at a location, at a time, and/or for specific users, for example).

According to some embodiments, a method is disclosed for a DI-based computerized framework for deterministically controlling and/or managing how/when content is displayed for specific users. In accordance with some embodiments, the present disclosure provides one or more computers comprising one or more processors and one or more non-transitory computer-readable storage media for carrying out the above-mentioned technical steps of the framework's functionality. The non-transitory computer-readable storage medium has tangibly stored thereon, or tangibly encoded thereon, computer readable instructions that when executed by a device cause a processor to perform a method for controlling and/or managing how/when content is displayed for specific users.

In accordance with one or more embodiments, a system is provided that includes one or more processors and/or computing devices configured to provide functionality in accordance with such embodiments. In accordance with some embodiments, functionality is embodied in steps of a method performed by at least one computing device. In accordance with one or more embodiments, program code (or program logic) executed by a processor(s) of a computing device to implement functionality in accordance with one or more such embodiments.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an example workflow according to some embodiments of the present disclosure;

FIG. 4 illustrates an example workflow according to some embodiments of the present disclosure;

FIG. 5 illustrates an example workflow according to some embodiments of the present disclosure;

FIG. 6 illustrates an example workflow according to some embodiments of the present disclosure;

FIG. 7 illustrates an example workflow according to some embodiments of the present disclosure;

FIG. 8 depicts an example implementation of an architecture according to some embodiments of the present disclosure;

FIG. 9 depicts an example implementation of an architecture according to some embodiments of the present disclosure; and

FIG. 10 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended, where the metes and bounds of the system is defined using different combinations of embodiments and functionality. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

While the term “some embodiments” or similar language is used herein, they do not denote separate frameworks, but instead emphasize configurations of a single system configured to execute any embodiment described herein. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. In some embodiments, one or more modules described herein may access functionality and/or programs stored on one or more remote computers and/or servers via a network connection.

For purposes of this disclosure, a “wireless network” should be understood to couple client devices (e.g., user equipment) with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device, which may include one or more computers, may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, user equipment such as a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, the disclosed framework provides integrated control and management of one or more devices and/or the applications executing thereon.

By way of a non-limiting example, according to some embodiments, the framework is configured to manage and control how content can be delivered to requesting users. According to some embodiments, as discussed infra, the framework can execute to render content unedited (e.g., when it is determined that no content or portion thereof requires censoring), partially censored and/or wholly censored. According to some embodiments, as discussed in more detail below, such censoring can involve, but is not limited to, modifying all or part of content, filtering the content, denying access to the content, overlaying a filter or other type of information (e.g., a content bar) that provides censorship, moving portions of the content to the background or foreground thereby rendering them illegible upon display, and the like, or some combination thereof.

According to some embodiments, the discussion herein may focus on embodiments related to censorship (e.g., covering body parts within images including digital representations of human bodies); however, these examples should not be construed as limiting, as it should be understood that the disclosed framework described herein can apply to various scenarios without departing from the scope of the instant disclosure. For example, the framework may be configured to prevent display of portions of an image that depict violence while in the geographical confines of a workspace. In some embodiments, the framework may be configured to identify objects associated with phobias, such as spiders, and cover the object and/or modify the object to be a less frightening creature, such as a bird or a fish as non-limiting examples. Such specific customization is not possible in the current state of the art.

According to some embodiments, as discussed above, embodiments exist where the disclosed framework can be applied with reference to geographical location. For example, in some embodiments, the framework may enable explicit material to be viewed on a user device while the user is at home, but may prevent and/or alter the same display when the user has entered a defined geographical area where it now becomes unwanted (e.g., at work).

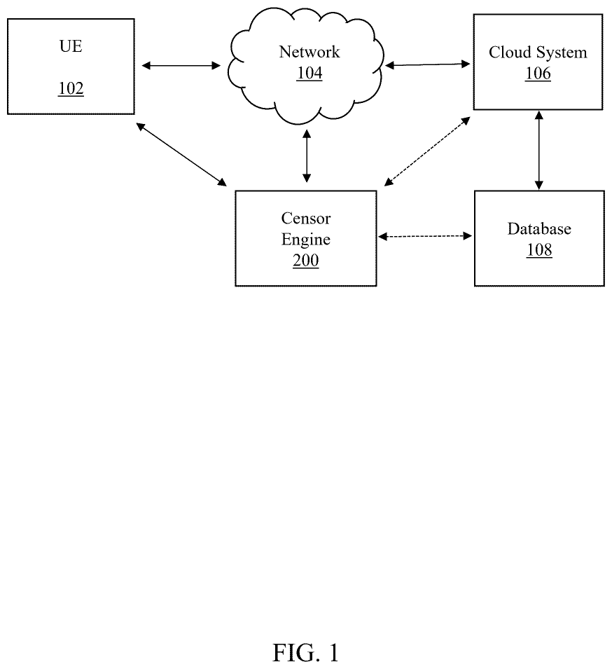

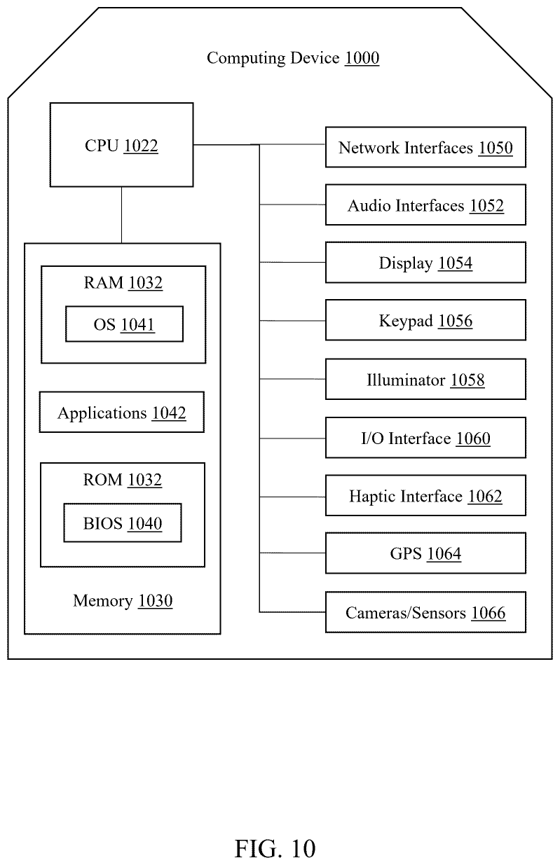

With reference to FIG. 1, system 100 is depicted which includes user equipment (UE) 102 (e.g., a computing device, as mentioned above and discussed below in relation to FIG. 10), network 104, cloud system 106, database 108 and censor engine 200. It should be understood that while system 100 is depicted as including such components, it should not be construed as limiting, as one of ordinary skill in the art would readily understand that varying numbers of UEs, cloud systems, databases and networks can be utilized. However, for purposes of explanation, system 100 is discussed in relation to the example depiction in FIG. 1.

According to some embodiments, the UE 102 can be any type of device, such as, but not limited to, a mobile (smart) phone, tablet, laptop, sensor, Internet-of-Things (IoT) device, autonomous machine, appliance, and/or any other device equipped with a cellular and/or wireless or wired transceiver and/or a display. For example, UE 102 can be a smart phone with various Apps installed, including one or more Apps interfacing with censor engine 200, which as discussed below in more detail, can enable the processing of received images to guide actual App and/or UE 102 output.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network-based system upon which applications, operations, and/or other forms of network resources may be located. For example, cloud system 106 may be a service provider and/or network provider from where services and/or applications may be accessed, sourced or executed from. For example, system 106 can represent the cloud-based architecture associated with a content, service and/or network provider, which has associated network resources hosted on the internet or private network (e.g., network 104), which enables (via censor engine 200) the device control and management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, and the services and applications provided by cloud system 106 and/or censor engine 200).

In some embodiments, for example, cloud system 106 can provide a private/proprietary management platform, whereby censor engine 200, discussed infra, corresponds to the novel functionality system 106 enables, hosts and provides to a network 104 and other devices/platforms operating thereon.

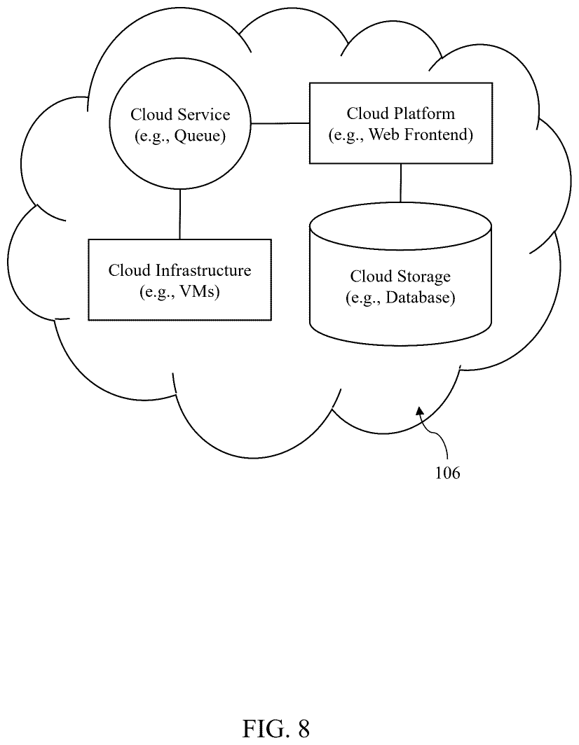

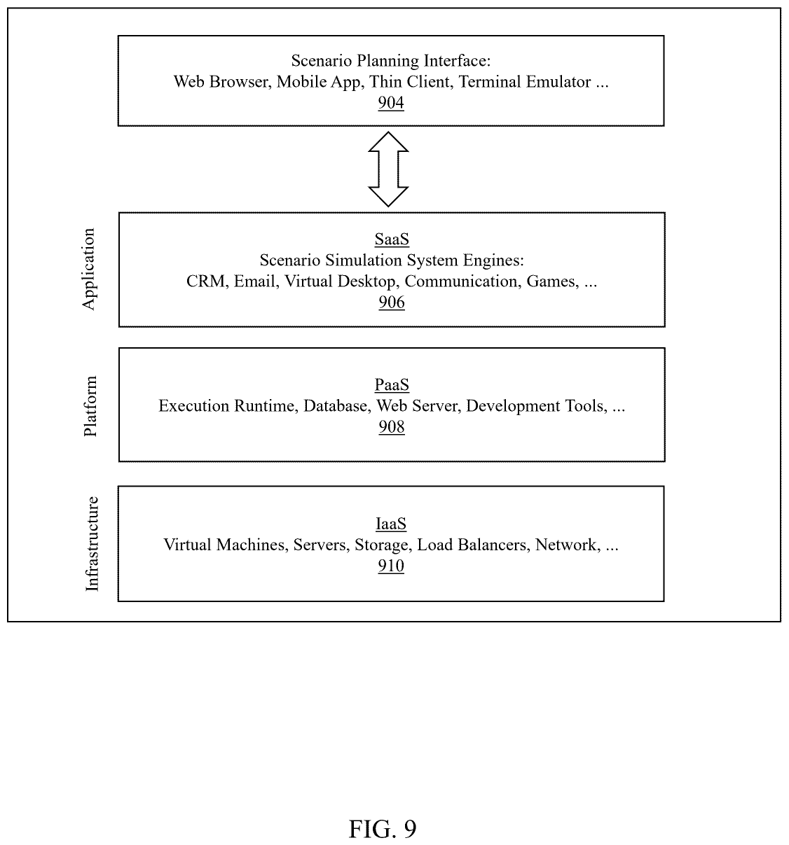

Turning to FIGS. 8 and 8, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 910, platform as a service (PaaS) 908, and/or software as a service (SaaS) 906 using a web browser, mobile app, thin client, terminal emulator or other endpoint 904. FIGS. 8 and 9 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, censor engine 200 (and associated microservices), which may be in any type of known or to be known format. According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository. In some embodiments, at least a portion of the database may be physically coupled to the UE 102, or a portion of the database may be physically remote from the UE, or a combination thereof.

Censor engine 200, as discussed above and further below in more detail, can include components for the disclosed functionality. According to some embodiments, censor engine 200 may include a special purpose machine or processor, and can be hosted by a device on network 104, within cloud system 106 and/or on UE 102. In some embodiments, censor engine 200 may be hosted by a server and/or set of servers associated with cloud system 106.

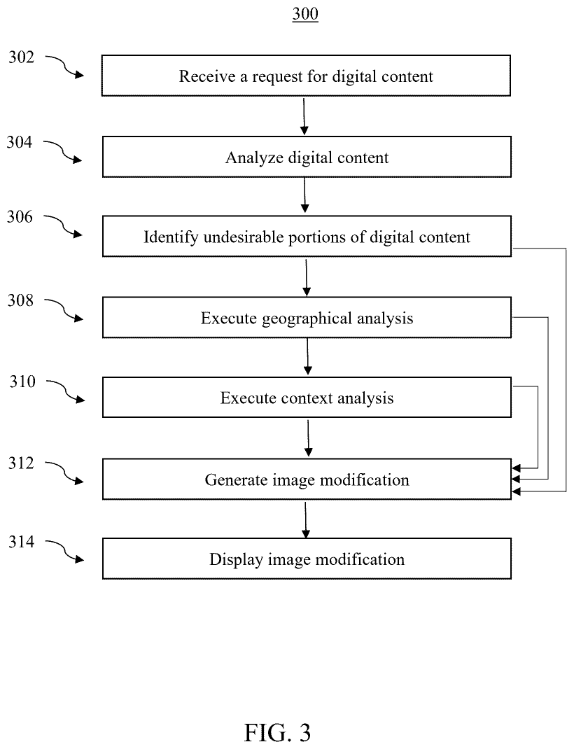

According to some embodiments, as discussed in more detail below, censor engine 200 may be configured to implement and/or control a plurality of services and/or microservices, where each of the plurality of services/microservices are configured to execute a plurality of workflows associated with performing the disclosed application control and management framework. Non-limiting embodiments of such workflows are provided below in relation to at least FIGS. 3-7.

According to some embodiments, as discussed above, censor engine 200 may function as an application provided by cloud system 106. In some embodiments, censor engine 200 may function as an application installed on a server(s), network location and/or other type of network resource associated with system 106. In some embodiments, censor engine 200 may function as an application installed and/or executing on UE 102. In some embodiments, such application may be a web-based application accessed by UE 102 over network 104 from cloud system 106. In some embodiments, censor engine 200 may be configured and/or installed as an augmenting script, program or application (e.g., a plug-in or extension) to another application or program provided by cloud system 106 and/or executing on UE 102.

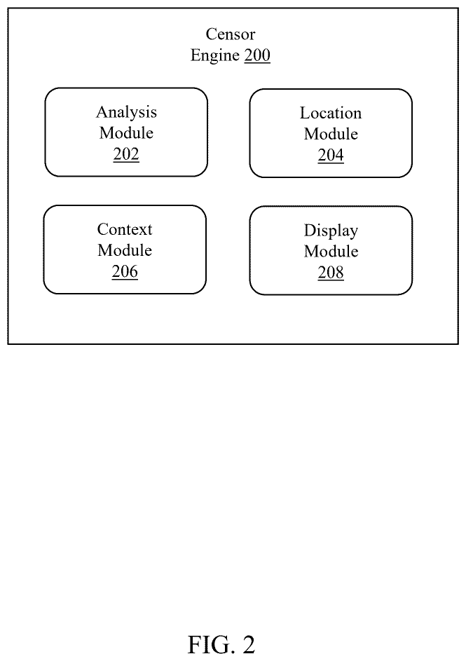

As illustrated in FIG. 2, according to some embodiments, censor engine 200 includes location module 202, analysis module 204, context module 206 and display module 208. It should be understood that the engine(s) and modules discussed herein are non-exhaustive, as additional or fewer engines and/or modules (or sub-modules) may be applicable to the embodiments of the systems and methods discussed. More detail of the operations, configurations, and functionalities of censor engine 200 and each of its modules, and their role within embodiments of the present disclosure will be discussed below.

Turning to FIG. 3, Process 300 provides non-limiting example embodiments for performing the disclosed censoring techniques. According to some embodiments, Steps 302-306 of process 300 can be performed by analysis module 202 of censor engine 200; Step 308 can be performed by location module 204; Step 310 can be performed by context module 206, and Steps 312-314 can be performed by display module 206.

According to some embodiments, Process 300 begins with Step 302 where engine 200 receives a request for digital content. In some embodiments, the content can be provided in response to a request for the digital content. For example, a user, via the smart phone, can request a web page, whereby the web page can constitute the received digital content (inclusive of the images, video, text, document object model (DOM), and the like, associated with the web page). In some embodiments, the content can be provided via an unsolicited request, for example, via the user playing a game, receiving a message, scrolling their feed, and the like.

As discussed above, such digital content may take the form of an image, a video, text or any electronic object, file or item that can be converted to a displayable and/or renderable form.

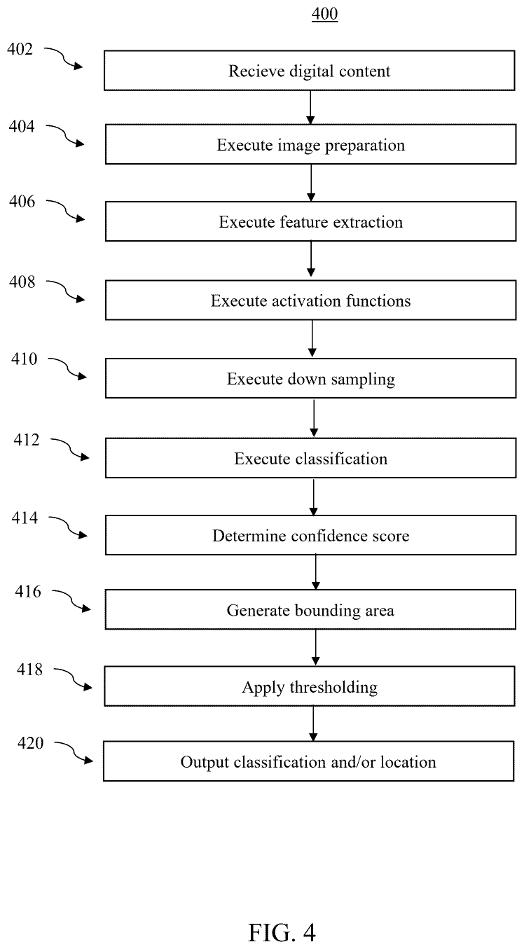

In Step 304, engine 200 can analyze the digital content. Details of some embodiments of the analysis performed in Step 304 are described in reference to FIG. 4, discussed infra. In general, as discussed infra, in some embodiments, analysis module 202 can parse the data/metadata of the content, and identify specific portions of digital content for modification. For example, in some embodiments, one or more AI models executed by the analysis module 202 can identify particular types of content (e.g., explicit adult content, violence and gore, hate speech and discrimination, illegal activities, harassment and/or cyberbullying, child exploitation, and the like, or some combination thereof). Based on such analysis, engine 200 can determine the undesirable portions of the digital content, as in Step 306 discussed infra.

In some embodiments, the analysis performed in Step 304 can involve engine 200 executing a specific trained AI/machine learning (ML) model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, censor engine 200 may be configured to utilize one or more AI/ML techniques selected from, but not limited to, computer vision, feature vector analysis, decision trees, boosting, support-vector machines, neural networks, nearest neighbor algorithms, naïve Bayes, bagging, random forests, logistic regression, and the like.

For example, in some embodiments, censor engine 200 can execute a Bayesian determination for the performance of content filtering by assessing the probability of certain images containing illicit content based on observed data. In some embodiments, these mechanisms continuously update determinations about whether an image is likely to belong to a specific category of illicit or unwanted content. In some embodiments, Bayesian reasoning can be used to incorporate prior knowledge or contextual information about background scene-related features, refining the assessment of whether the scene matches a particular context, where such determination can be used to determine a type of context modification.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model for the control framework,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained AI model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained AI model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Turning to FIG. 4, Process 400 provides a non-limiting example embodiment for performing the analysis of Step 306, discussed supra.

According to some embodiments, Process 400 begins with Step 402 where the analysis module 202 receives the digital content (from Step 302, discussed supra). In this non-limiting example, and for purposes of discussing the steps of FIG. 4, the digital content includes an image.

In Step 404, module 202 can perform preparations of the image. In some embodiments, the preparation may include one or more of resizing, normalization of pixel values, and/or converting the image into a format suitable for evaluation and management via engine 200.

In Step 406, the image can be passed through a series of convolutional layers in a CNN in this non-limiting example. These layers learn and extract hierarchical features, detecting edges, textures, shapes, and patterns at different levels of abstraction.

After convolutional layers, in some embodiment's activation functions are used to introduce non-linearities to the model, allowing it to capture complex relationships within the image at Step 408. In some embodiments, down sampling can occur in Step 410, where reductions to the spatial resolution can be performed by applying convolutional operations with larger strides (skipping pixels) or by using specific layers (such as strided convolutional layers) to directly reduce the spatial dimensions of feature maps. In some embodiments, the analysis module 202 is configured to partition each feature map into smaller non-overlapping regions (e.g., squares of 2×2 or 3×3 pixels) and perform operations within these regions, which may include max pooling (selecting the maximum value), average pooling (calculating the average), or other pooling operations, reducing each region to a single value.

In Step 412, the analysis module 202 executes a classification of the image. Extracted features are fed into fully connected layers, performing classification or regression tasks. In body part detection within an image, this stage determines if the identified features correspond to a particular body. In Step 414, a confidence score is assigned at the final output layer to provide probability or confidence score that the analyzed image contains the body part based on learned features. Such scoring can be based on application of any type of known or to be known AI/ML-based probability model.

In Step 416, a bound area is defined and formed around the identified body part, indicating its location within the image. In some embodiments, display module 208 can be called, which can be configured to apply a predetermined overlay within the bounding area should the context module feature be skipped, as discussed infra.

In Step 418, a confidence threshold is determined, which can be leveraged to determine whether the identified features constitute the body part (e.g., an undesirable body part). In some embodiments, if the confidence score equals to or surpasses the threshold, the AI model concludes that the body part is present. In Step 420, module 202 can output one or more of the coordinates of the detected body part, confidence scores, and a binary classification indicating the presence or absence of the body part. Such information can be stored in database 108.

Turning back to Process 300, upon performing the processing of Step 306, engine 200 can proceed to Step 312 or Step 308. In some embodiments, a determination can be made whether a location-based analysis is warranted (e.g., “is the user at their home?,” for example). Should the location-based analysis not be required, processing can proceed to Step 312, discussed infra. However, should it be determined by engine 200 that location processing is required, then processing can proceed to Step 308.

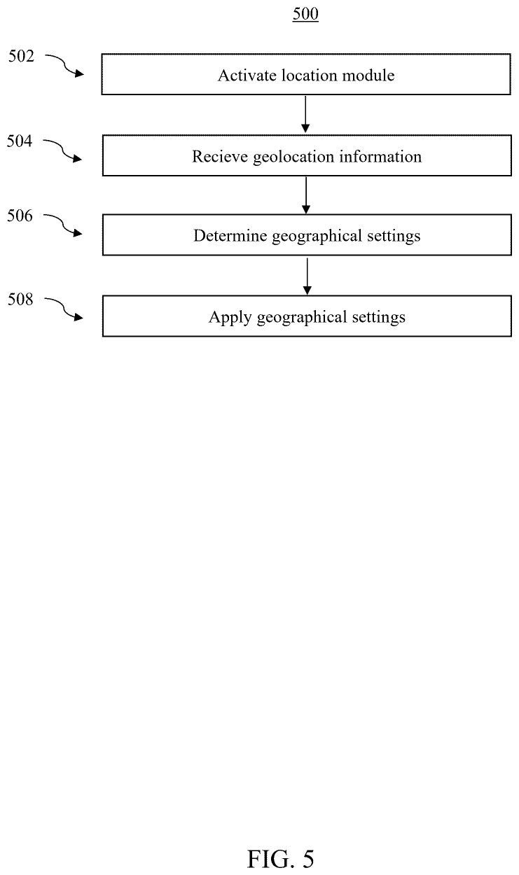

Turning to FIG. 5, Process 500 provides a non-limiting example embodiment for performing the execution of geographical analysis of Step 308. In Step 502, the location module 204 receives an activation command, which can be received from engine 200, module 202, the user, the content provider, an administrator, and the like, or some combination thereof.

In Step 504, location module 204 can receive the geolocation information of the user. For example, such location information can be based on, but not limited to, GPS data, Internet Protocol (IP) address, WiFi positioning and/or any other type of information that can be used to identify a user's current location.

In Step 506, the location module 204 determines the settings for the geographical area. Such settings can be based on, but not limited to, where the user is, what type of user, type of device, type of content, type of application, time, date, and the like, or some combination thereof.

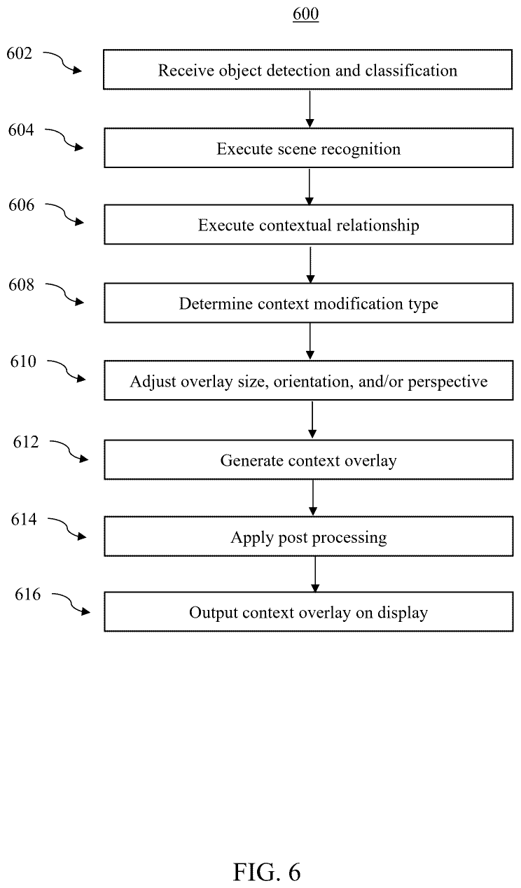

In Step 508, the geographical settings are applied. In some embodiments, a particular type of modification of, in this example, the body part and/or body area can be specific to a geographical region. For example, a bikini can be turned into a full body swimsuit with an overlay around a specific area (e.g., in some embodiments, the type of swimsuit, and whether a more reserved covering is applied can be based on a region (e.g., United States versus Saudi Arabia, for example). This functionality incorporates a context evaluation of the image, which is explained with reference to FIG. 6, discussed infra.

In some embodiments, landmark detection algorithms are configured to identify specific points or landmarks on a body part, such as eyes, nose, mouth corners, on a face, for example. Some embodiments utilize one or more machine learning models like CNNs, while some embodiments employ algorithms such as Active Shape Models (ASMs) or Active Appearance Models (AAMs). Once landmarks are detected, algorithms can use this information to accurately position and align masks onto the face by recognizing key facial structures. The same techniques described herein with regard to a face can be applied to any body part or section of a body (e.g., genitalia), or to any structure in general, to automatically generate an overlay for that section. The technique to establish a context for an identified body part is further explained below.

In some embodiments, Haar cascades are used for object detection. These algorithms work by identifying patterns of pixel intensity that are characteristic of specific objects or features (e.g., the arrangement of pixels in a face). Haar cascades can be employed to identify regions of interest (ROI), such as faces, which can then guide the positioning and sizing of masks on the identified areas.

In some embodiments, the engine 200 can segmentation techniques to apply a mask overlay to an image. Image segmentation divides an image into multiple segments or regions based on similar characteristics. Techniques like GrabCut, Watershed, or semantic segmentation models (like U-Net or Mask R-CNN) can identify the boundaries of objects, aiding in precise masking. In some embodiments, segmentation execution helps isolate the body part or section, facilitating the accurate application of masks to the identified region.

In some embodiments, morphological operations (like erosion, dilation, opening, and closing) and image processing techniques are used to manipulate images based on their shapes and structures. These operations modify the geometrical structure of images and are used in tasks like noise reduction, edge detection, and refining masks. They can refine the mask's boundaries or enhance its compatibility with the identified face or body part.

Depending on the architecture, computer vision algorithms for mask overlay generation can reside in any module within the censor engine, or may be its own module. In general, the steps executed by the computer vision algorithm include: employ an object detection or segmentation model to identify the face/body part; utilize computer vision algorithms to generate or overlay masks onto the identified regions; and display the processed images.

Turning back to Process 300, upon performing the processing of Step 308, engine 200 can proceed to Step 312 or Step 310. In some embodiments, a determination can be made whether a contextual-based analysis is warranted. Should the contextual-based analysis not be required, processing can proceed to Step 312, discussed infra. However, should it be determined by engine 200 that contextual processing is required, then processing can proceed to Step 310.

Turning to FIG. 6, Process 600 provides a non-limiting example embodiment for performing the execution of contextual analysis of Step 310.

In Step 602, the context module 206 receives the digital content with the body part identified, which in this non-limiting example includes images of women in bikinis. In Step 604, the context module 2069 executes one or more AI/ML models capable of detecting various objects and scenes within the image. As discussed above, in a similar manner, such AI/ML models are trained to recognize and categorize different environments or settings, including beaches, parks, cities, and the like. In some embodiments, the one or more models are configured to identify beach-related objects like sand, water, umbrellas, or beach chairs, and/or are trained to recognize specific visual cues that indicate a beach context, such as sand, sea waves, palm trees, beach umbrellas, swimwear, or beach-related activities.

In Step 606, the context module 206 is configured to determine the contextual modification type. In this example, the location module has identified the user is in a conservative area, the analysis module has identified subject matter in the digital content considered offensive (in this case bare skin on women), and the context module has determined the environment the offensive material is presented in. In some embodiments, at Step 608 the context module 206 is configured to apply a logic decision to apply appropriate mask overlays based on a match between a recognized feature and a scene context, which in this case would be covering the skin. However, any mask could be applied based on the settings within the logic.

In Step 610, the context module 206 executes an adjustment of the full body swimsuit to match the bare skin, which may include adjusting the size, orientation, and perspective of the full body bathing suit. In some embodiments, the context module 206 is configured to overlay the full body swimsuit overlay mask to over existing swimwear identified features if any is identified using one or more techniques described herein to present a more natural look.

In Step 612, the context overlay is generated. In some embodiments, the context module is configured to apply post-processing techniques to refine the appearance of the mask overlay, such as adjusting transparency, color, or adding shadow effects for a more natural look, as in Step 614. The context overlay is output in Step 616 for display on the UE 102.

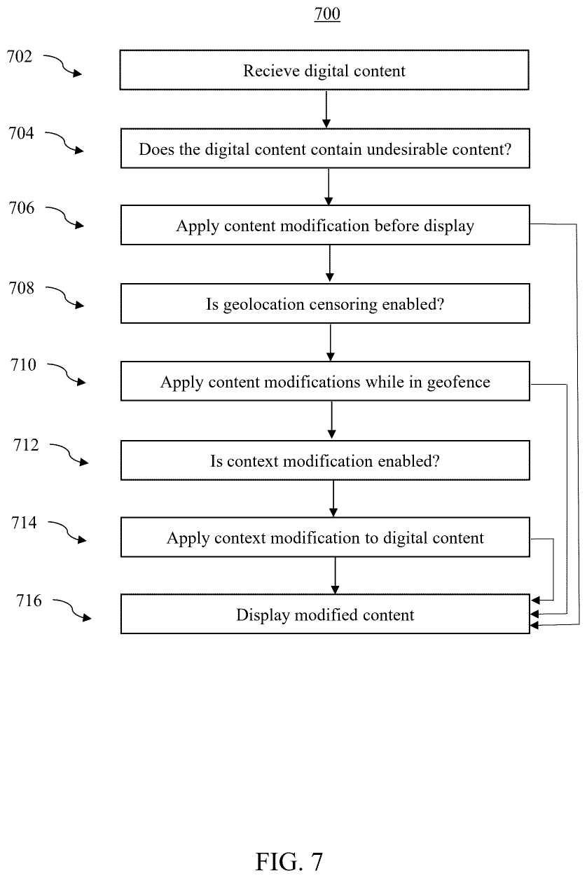

Turning back to Process 300, upon performing the processing of Step 310, engine 200 can proceed to Step 312, which is discussed with reference to Process 700 of FIG. 7.

Process 700 begins with Step 702, where the display module 208 receives the digital content (which can be from Step 306, 308 or 310, as discussed supra).

In Step 704, the display module 208 determines whether the digital content contains undesirable content, which can be provided and/or determined via the results from the preceding Step 306, 308 or 310, as discussed supra. In Step 706, in some embodiments, content modifications can be performed, as discussed above (e.g., obfuscate, alter, apply a filter, and the like). In some embodiments, if the location module 204 and context module 206 are disabled, the display module 208 displays the digital content with an overlay covering the bounding area as previously described.

In Step 708, the display module 208 determines if the location module 204 is active, and, if so, applies the overlay while in the geographical location, as in Step 710. In Step 712, the display module 208 determines if the context module 206 has generated a context overlay, and, if so, applies the context overlay, as in Step 714. In Step 716, the final modified digital content is displayed on the UE 102, as also performed in Step 314 of FIG. 3.

In some embodiments, the order of these steps may execute differently than shown in FIG. 7. For example, the analysis, location, and context determinations may be made substantially simultaneously or in various orders.

In some embodiments, training one or more AI models involves an initial stage that includes assembling a diverse dataset of images featuring the specific digital content (e.g., body parts or objects) for detection. These images are labeled or annotated, marking the areas of interest, like bounding boxes around faces. Next, the data is prepared by resizing the images to a consistent dimension, usually 224×224 pixels, to maintain uniformity. In some embodiments, for non-essential color information, consider images were to grayscale to streamline computational processing. In some embodiments, a step for training includes augment the dataset by applying various transformations, like rotations or flips, enhancing its diversity. In some embodiments, normalization of pixel values is executed to standardize the range typically between 0 and 1 or −1 and 1. This normalization aids in faster model convergence during training by ensuring uniformity in input data.

In some embodiments, a step includes splitting the training data into three subsets: the training set, the validation set, and the testing set. The training set, the largest segment, is used to teach the model patterns and relationships between input data and labels. In some embodiments, the AI model uses the training set to refine its predictive abilities by minimizing prediction differences from actual labels using optimization methods like gradient descent during numerous training iterations or epochs. A smaller validation set helps fine-tune model parameters without bias, evaluating its performance on unseen data throughout training. Performance metrics guide decisions on fine-tuning without overfitting. The testing set should be entirely new to the model, and is used by the model to evaluate its generalization and performance on unseen data after training and hyperparameter tuning. This unbiased assessment determines the model's real-world performance.

The techniques and exaction steps described above can also be applied to text, although additional models may be used to determine text and/or context. For example, in some embodiments, transformer-based models are employed to recognize text: a type of neural network architecture designed for understanding context in sequential data, particularly in language-related tasks, and include Generative Pre-trained Transformer (GPT) series models, as non-limiting examples. Natural Language Processing (NLP) are used to execute word embedding techniques to convert words into numerical vectors to capture semantic relationships and are used as part of larger NLP models or applications in some embodiments. The steps taken by one or more modules of the censor engine 200 for identifying unwanted content in text, processing location and context, and displaying an overlay are the same as listed above and will not be repeated in the interest of being concise.

Other NLP steps executed may include using predefined rules and patterns to perform specific language tasks like tokenization, stemming, or parsing. In some embodiments, statistical models utilize statistical algorithms and probabilistic approaches for tasks such as language modeling, part-of-speech tagging, or named entity recognition. In some embodiments, machine learning models, which may include supervised and unsupervised learning models (e.g., Support Vector Machines, Random Forests) are trained on labeled or unlabeled data for tasks like sentiment analysis, text classification, or machine translation. In some embodiments, neural network architectures, including Recurrent Neural Networks (RNNs), Long Short-Term Memory networks (LSTMs), and Transformer models (e.g., BERT, GPT), are used in sequence modeling, language understanding, and generation tasks.

FIG. 10 is a schematic diagram illustrating a client computing device showing an example embodiment of a client device that may be used within the present disclosure and/or the framework illustrated in FIG. 1. Computing device 1000 may include many more or less components than those shown in FIG. 10, such as a plurality of one or more computers. However, the components shown are sufficient to disclose an illustrative embodiment for implementing the present disclosure. Client device 1000 may represent, for example, UE 102 discussed above at least in relation to FIG. 1.

As shown in the figure, in some embodiments, client device 1000 includes one or more processors (CPU) 1022 in communication with one or more non-transitory computer readable media 1030 via a bus 1024. Client device 1000 also includes a power supply 1026, one or more network interfaces 1050, an audio interface 1052, a display 1054, a keypad 1056, an illuminator 1058, an input/output interface 1060, a haptic interface 1062, an optional global positioning systems (GPS) receiver 1064 and a camera(s) or other optical, thermal or electromagnetic sensors 1066. Device 1000 can include one camera/sensor 1066, or a plurality of cameras/sensors 1066, as understood by those of skill in the art. Power supply 1026 provides power to client device 1000.

Computing device 1000 may optionally communicate with a base station (not shown), or directly with another computing device. In some embodiments, network interface 1050 is sometimes known as a transceiver, transceiving device, or network interface card (NIC).

Audio interface 1052 is arranged to produce and receive audio signals such as the sound of a human voice in some embodiments. Display 1054 may be a liquid crystal display (LCD), gas plasma, light emitting diode (LED), or any other type of display used with a computing device. Display 1054 may also include a touch sensitive screen arranged to receive input from an object such as a stylus or a digit from a human hand.

Keypad 1056 may include any input device arranged to receive input from a user. Illuminator 1058 may provide a status indication and/or provide light.

Client device 1000 also includes input/output interface 1060 for communicating with external. Input/output interface 1060 can utilize one or more communication technologies, such as USB, infrared, Bluetooth™, or the like in some embodiments. Haptic interface 1062 is arranged to provide tactile feedback to a user of the client device.

Optional GPS transceiver 1064 can determine the physical coordinates of computing device 1000 on the surface of the Earth, which typically outputs a location as latitude and longitude values. GPS transceiver 1064 can also employ other geo-positioning mechanisms, including, but not limited to, triangulation, assisted GPS (AGPS), E-OTD, CI, SAI, ETA, BSS or the like, to further determine the physical location of client device 1000 on the surface of the Earth. In one embodiment, however, client device may through other components, provide other information that may be employed to determine a physical location of the device, including for example, a MAC address, Internet Protocol (IP) address, or the like.

Mass memory 1030 includes a RAM 1032, a ROM 1034, and other storage means. Mass memory 1030 illustrates another example of computer storage media for storage of information such as computer readable instructions, data structures, program modules, usage data, or other data. Mass memory 1030 stores a basic input/output system (“BIOS”) 1040 for controlling low-level operation of computing device 1000. The mass memory also stores an operating system 1041 for controlling the operation of client device 1000.

Memory 1030 further includes one or more data stores, which can be utilized by client device 1000 to store, among other things, applications 1042 and/or other information or data. For example, data stores may be employed to store information that describes various capabilities of client device 1000. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within client device 1000.

Applications 1042 may include computer executable instructions which, when executed by client device 1000, transmit, receive, and/or otherwise process audio, video, images, and enable telecommunication with a server and/or another user of another client device. Applications 1042 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:

Aspect 1. A method comprising:
receiving, over a network, a request for digital content;
analyzing, prior to display of the digital content on a device of a user, the digital content via an artificial intelligence (AI) model, the analysis comprising executing the AI model with at least information related to the digital content as the input;
determining, based on the AI-based analysis, that the digital content requires censorship, the censorship determination being based on a criteria related to the request;
modifying, via the AI model, the digital content based on the censorship determination, the modification comprising altering at least a portion of the digital content from an original version to a modified version; and
causing display, on a display of the device of the user, the modified digital content item.
   Aspect 2. The method of aspect 1, further comprising:
determining, via the AI-based analysis, a set of regions of the digital content, the regions corresponding to bounded areas of a viewable area of the digital content;
analyzing each of the set of regions; and
performing the censorship determination based on the analysis of the set of regions.
   Aspect 3. The method of aspect 1, wherein a region within the set of regions includes at least a portion of content that corresponds to the criteria, wherein the modification of the digital content corresponds to the region.
   Aspect 4. The method of aspect 1, wherein the criteria corresponds to at least one of an identity (ID) of the user, type of user, location of the user device, time, type of device, type of browser and type of application.
   Aspect 5. The method of aspect 4, further comprising:
analyzing the criteria defined by the location of the user device;
determining that the user device is proximately located at the location; and
performing the modification based on the determination that the user device is at the location.
   Aspect 6. The method of aspect 4, wherein a type of the modification is based at least in part on a type of the criteria.
   Aspect 7. The method of aspect 1, wherein the modification comprises at least one of editing, filtering, altering, obfuscating and preventing at least a portion of the display of the digital content.
   Aspect 8. The method of aspect 1, wherein the digital content comprises at least one of text, images, video, multi-media and audio.
   Aspect 9. The method of aspect 1, further comprising:
determining, based on the AI-based analysis, that censorship is not required; and
causing display of the digital content without censorship.
   Aspect 10. The method of aspect 1, wherein the request for digital content corresponds to at least one of a communication from the user device or a communication from another device

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, over a network, a request for digital content;
analyzing, prior to display of the digital content on a device of a user, the digital content via an artificial intelligence (AI) model, the analysis comprising executing the AI model with at least information related to the digital content as the input;
determining, based on the AI-based analysis, that the digital content requires censorship, the censorship determination being based on a criteria related to the request;
modifying, via the AI model, the digital content based on the censorship determination, the modification comprising altering at least a portion of the digital content from an original version to a modified version; and
causing display, on a display of the device of the user, the modified digital content item.

2. The method of claim 1, further comprising:
determining, via the AI-based analysis, a set of regions of the digital content, the regions corresponding to bounded areas of a viewable area of the digital content;
analyzing each of the set of regions; and
performing the censorship determination based on the analysis of the set of regions.

3. The method of claim 1, wherein a region within the set of regions includes at least a portion of content that corresponds to the criteria, wherein the modification of the digital content corresponds to the region.

4. The method of claim 1, wherein the criteria corresponds to at least one of an identity (ID) of the user, type of user, location of the user device, time, type of device, type of browser and type of application.

5. The method of claim 4, further comprising:
analyzing the criteria defined by the location of the user device;
determining that the user device is proximately located at the location; and
performing the modification based on the determination that the user device is at the location.

6. The method of claim 4, wherein a type of the modification is based at least in part on a type of the criteria.

7. The method of claim 1, wherein the modification comprises at least one of editing, filtering, altering, obfuscating and preventing at least a portion of the display of the digital content.

8. The method of claim 1, wherein the digital content comprises at least one of text, images, video, multi-media and audio.

9. The method of claim 1, further comprising:
determining, based on the AI-based analysis, that censorship is not required; and
causing display of the digital content without censorship.

10. The method of claim 1, wherein the request for digital content corresponds to at least one of a communication from the user device or a communication from another device.

11. A system comprising:
a processor configured to:
receiving, over a network, a request for digital content;
analyzing, prior to display of the digital content on a device of a user, the digital content via an artificial intelligence (AI) model, the analysis comprising executing the AI model with at least information related to the digital content as the input;
determining, based on the AI-based analysis, that the digital content requires censorship, the censorship determination being based on a criteria related to the request;
modifying, via the AI model, the digital content based on the censorship determination, the modification comprising altering at least a portion of the digital content from an original version to a modified version; and
causing display, on a display of the device of the user, the modified digital content item.

12. The system of claim 11 wherein the processor is further configured to:
determine, via the AI-based analysis, a set of regions of the digital content, the regions corresponding to bounded areas of a viewable area of the digital content;
analyze each of the set of regions; and
perform the censorship determination based on the analysis of the set of regions.

13. The system of claim 11, wherein a region within the set of regions includes at least a portion of content that corresponds to the criteria, wherein the modification of the digital content corresponds to the region.

14. The system of claim 11, wherein the criteria corresponds to at least one of an identity (ID) of the user, type of user, location of the user device, time, type of device, type of browser and type of application.

15. The system of claim 14, wherein the processor is further configured to:
analyze the criteria defined by the location of the user device;
determine that the user device is proximately located at the location; and
perform the modification based on the determination that the user device is at the location.

16. A non-transitory computer-readable storage medium tangibly encoded with computer-executable instructions, that when executed by a processor, perform a method comprising:
receiving, over a network, a request for digital content;
analyzing, prior to display of the digital content on a device of a user, the digital content via an artificial intelligence (AI) model, the analysis comprising executing the AI model with at least information related to the digital content as the input;
determining, based on the AI-based analysis, that the digital content requires censorship, the censorship determination being based on a criteria related to the request;
modifying, via the AI model, the digital content based on the censorship determination, the modification comprising altering at least a portion of the digital content from an original version to a modified version; and
causing display, on a display of the device of the user, the modified digital content item.

17. The non-transitory computer-readable storage medium of claim 16, further comprising:
determining, via the AI-based analysis, a set of regions of the digital content, the regions corresponding to bounded areas of a viewable area of the digital content;
analyzing each of the set of regions; and
performing the censorship determination based on the analysis of the set of regions.

18. The non-transitory computer-readable storage medium of claim 16, wherein a region within the set of regions includes at least a portion of content that corresponds to the criteria, wherein the modification of the digital content corresponds to the region.

19. The non-transitory computer-readable storage medium of claim 16, wherein the criteria corresponds to at least one of an identity (ID) of the user, type of user, location of the user device, time, type of device, type of browser and type of application.

20. The non-transitory computer-readable storage medium of claim 19, further comprising:
analyzing the criteria defined by the location of the user device;
determining that the user device is proximately located at the location; and
performing the modification based on the determination that the user device is at the location.
